(19) United States
(12) Patent Application Publication
(10) Pub. No.: US 2021/0392121 A1
(43) Pub. Date: Dec. 16, 2021

(54) IKE AND IPSEC STATE MIGRATION

(71) Applicant: MICROSOFT TECHNOLOGY LICENSING, LLC, Redmond, WA (US)

(72) Inventors: Shivakumar Thangapandi, Redmond, WA (US); Abhishek Gupta, Redmond, WA (US); Vikrant Arora, Redmond, WA (US)

(21) Appl. No.: 16/990,856

(22) Filed: Aug. 11, 2020

Related U.S. Application Data
(60) Provisional application No. 63/038,017, filed on Jun. 11, 2020.

(51) Int. Cl. H04L 29/06; G06F 9/455; H04L 29/08

(52) U.S. Cl. CPC H04L 63/0485; H04L 63/029; H04L 63/061; G06F 2009/45595; G06F 9/45558; H04L 67/1002; H04L 63/0876

(57) ABSTRACT

Techniques are disclosed for live migrating an existing connection between a local gateway in a virtualized computing environment and a remote gateway. The existing IKE and IPSec connection are frozen. MMSA and QMSA data for the IKE and IPSec connection are saved. Data for the existing IKE and IPSec connection is cleared at the local gateway without sending a message to the remote gateway. The saved MMSA and QMSA data are transferred to a new local gateway. Using the saved MMSA and QMSA data, a state for the existing IKE and IPSec connection is reconstructed at the new local gateway. The existing IKE and IPSec connection is enabled.

### RELATED PRIORITY APPLICATION

The present application is a non-provisional application of, and claims priority to, the earlier filed U.S. Provisional Application Ser. No. 63/038,017 filed on Jun. 11, 2020, the contents of the listed application are hereby incorporated by reference in their entirety.

### BACKGROUND

Datacenters typically house computer systems and various networking, storage, and other related components. Datacenters may provide computing services to businesses and individuals as a remote computing service or provide “software as a service” (e.g., cloud computing). To facilitate efficient utilization of data center resources, virtualization technologies allow a physical computing device to host one or more virtual machines (VMs) that appear and operate as independent computer devices to a connected user. The datacenter can create, maintain or delete virtual machines in a dynamic manner.

A datacenter may implement one or more virtual network gateways to send/receive encrypted traffic between a virtual network and an on-premises location over a network such as the Internet. A virtual network gateway may comprise two or more virtual machines that are deployed to a gateway subnet. It is with respect to these considerations and others that the disclosure made herein is presented.

### SUMMARY

In some embodiments, a virtual network gateway may be implemented as an active-passive VPN gateway which may comprise two instances in an active-standby configuration. One gateway instance may be an active instance, and the second gateway instance may be the backup or passive instance. The gateway may be implemented with a virtual IP (VIP) that users may configure for access to their virtual services. The VIP may be coupled to a load balancer to provide scalability and availability. The load balancer may be configured to distribute inbound flows that arrive on the load balancer's frontend to backend virtual resources and translate private IP addresses to public IP addresses and vice versa. The load balancer may be configured to load-balance incoming Internet traffic to the virtual machines in a virtual network. For example, incoming traffic that arrives at the frontend may be distributed to backend virtual resources.

Internet Protocol Security (IPsec) may be used to authenticate and encrypt data to provide secure encrypted communication between two endpoints, such as client and datacenter endpoints that connect via a virtual private network (VPN). IPsec includes protocols for establishing mutual authentication between the endpoints and negotiation of cryptographic keys to use during the communication session. Internet Key Exchange (IKE) protocol may be used to set up a security association (SA) in the IPsec protocol suite and is a VPN tunneling protocol used to securely communicate between two networks. The secure connection is established by negotiating the authentication, cryptographic algorithms, encryption and decryption keys between two communicating devices (e.g., gateways). These negotiated parameters are then used to protect the data sent between the gateways.

Currently there is no way to retrieve, migrate and restore the IKE and IPSec SA state from one device to another device. For example, in the event of gateway maintenance, or if it desired to move connections to a different gateway for load balancing, existing connections to the old gateway will need to be disconnected and reconnected to the new gateway. This can cause connection downtime because if the client device is behind a network address translation (NAT), then until the client device initiates the connection, the connection cannot be re-established. Additionally, if the connection has not been configured for autodialing, then the connection cannot be established until the remote site dials manually.

In various embodiments disclosed herein, the current IKE and IPSec SA state for the current gateway may be retrieved and migrated to the new gateway and the states may be restored to reconstruct the IKE and IPSec SAs on the new gateway. By migrating the negotiated SAs and its associated parameters to the backup gateway, connection downtime may be avoided during events such as planned maintenance of the gateway, or for load balancing purposes. Using this data on the new device, the IKE and IPSec state can be reconstructed without the need to exchange packets to the remote device. Hence, the remote (client) device will not detect that existing connections have been disconnected, and data packets may continue to flow in either direction.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### DRAWINGS

The Detailed Description is described with reference to the accompanying figures. In the description detailed herein, references are made to the accompanying drawings that form a part hereof, and that show, by way of illustration, specific embodiments or examples. The drawings herein are not drawn to scale. Like numerals represent like elements throughout the several figures.

FIG. 1 is a diagram illustrating a data center for providing virtualized resources in accordance with the present disclosure;

FIG. 2 is a diagram illustrating a load balancer and gateway instances in accordance with the present disclosure;

FIG. 3 is a flowchart depicting an example procedure for live migrating an existing connection between a local gateway in a virtualized computing environment and a remote gateway in accordance with the present disclosure;

FIG. 4 is a flowchart depicting an example procedure for live migrating an existing connection between a local gateway in a virtualized computing environment and a remote gateway in accordance with the present disclosure;

FIG. 5 is an example computing device in accordance with the present disclosure.

### DETAILED DESCRIPTION

IKE is an IPSec based VPN tunneling protocol that is typically used to securely communicate between two networks. The secure connection is established by negotiating an authentication algorithm, cryptographic algorithm, cryptographic keys, and other parameters defined in the IKE protocol between two communicating devices (e.g., gateways). These negotiated parameters may then be used to protect the data sent between the gateways.

There are various scenarios in which the connection needs to be disconnected and reconnected either from the same device or a different device. For example, it may be desired to switch from a primary gateway to a backup gateway. In another example, it may be determined that the existing connections to a gateway are nearing capacity, and it may be desirable to migrate some connections to other gateways for load balancing purposes. However, moving an existing connection can cause significant downtime for the connection.

One such scenario is when the gateway needs to be upgraded for maintenance. In the event of gateway maintenance, the connection needs to be disconnected and could be reconnected from/to a backup device. This can cause a downtime as it involves disconnecting the existing connection and making a new connection. This downtime can be significant if the remote device is behind a NAT since the connection will be over a nonstandard port and until the remote device initiates a new connection, the connection cannot be re-established. Additionally, if the connection has been configured for manual dialing, then the connection cannot be established until the remote site dials.

Another scenario is when a connection needs to be moved from one gateway to another gateway for performance reasons or for load balancing. If a connection's bandwidth requirement cannot be met with the existing gateway device, then the connection can be moved to a different gateway that has the required bandwidth. This also can cause significant downtime.

To avoid this downtime, the negotiated SAs and its associated parameters can be saved and migrated to a new gateway. Using this data on the new device, the IKE and IPSec state can be reconstructed without the need to exchange connection data with the remote device. As a result, the new device will not detect that the connection has been lost and data packets will continue to flow in either direction.

A virtual private connection typically involves IKE and IPSec. IKE is the control message protocol and IPSec is the data path protocol. IKE and IPSec each have their own set of parameters that are defined as a Security Associations (SA). The IKE SA is the Main Mode SA (MMSA) and the IPSec SA is the Quick Mode SA (QMSA). A connection can have one or more MMSAs and QMSAs. The MMSAs and QMSAs are created after the successful establishment of the connection between two VPN gateways. The MMSAs and QMSAs includes the information required to successfully communicate and maintain the connection between the two gateways.

To migrate the MMSA state, the following parameters are collected from the gateway where the MMSA was created:

The IKE policy. The IKE policy is defined by the gateway administrator and includes the configuration information required to negotiate and establish an IKE connection. The MMSA is created based on the negotiated parameters from the IKE policy of both gateways.

Connection protocol and type. The connection may be based on IKEv1 or IKEv2 and may be established in tunnel mode or transport mode.

The IP address of the local and remote gateway.

The time when the MMSA was created.

The initiator and responder of the MMSA.

The current state of the MMSA. The MMSA may be in the process of being established, deleted, a rekey in progress, DPD in progress, or the MMSA may be fully established.

Local and remote authentication protocols that were used for authenticating the gateways.

NAT parameters. Information about which gateway is behind the NAT and its corresponding NAT'd port number and original IP address.

Initiator and Responder cookie. These may be used to uniquely identify the IKE connection that were exchanged when the connection was established.

Cryptographic parameters. These include the cipher and integrity algorithm and its associated keys, Diffie-Hellman group, local and remote nonce and Initialization Vector.

Next incoming IKE request and response message ID

Number of QMSAs and its corresponding state

The following parameters are collected from the gateway where the QMSA was created:

MMSA identifier corresponding to this QMSA

The time when the QMSA was created

The initiator and responder of the QMSA

The current state of the QMSA. The QMSA may be in the process of being established, deleted, rekey in progress, or the QMSA may be fully established.

Local and remote Security Parameter Index

Number of negotiated Traffic Selectors and their details. The traffic selectors are the local and remote address ranges that will be used to match the traffic permitted over the IPSec connection.

QMSA Protocol. Authentication Header (AH) or Encapsulating Security Payload (ESP)

Cryptographic parameters. These include the cipher algorithm, authentication algorithm and PFS Group.

QM key material used to derive keys for the cryptographic algorithms

Next outgoing sequence number and range of incoming sequence numbers

In one embodiment, the following sequence of events may be followed for successfully migrating the IKE and IPSec state from one gateway to another.

Freeze the IKE and IPSec connection so that no packets are processed. This is performed to ensure that the IKE message ID and IPSec sequence numbers do not change.

Save the connection's MMSA and QMSA data

Delete the MMSA and QMSA from the original device without sending an SA_DELETE message to the remote device

Transfer the saved data to the device from which the connection needs to be established

Using the MMSA and QMSA data, reconstruct the IKE and IPSec state

Based on the SA establishment time in the migrated data, the timers may be readjusted to ensure that the SAs expire and rekeys happen at the right time.

The connection is migrated, and the connection can process traffic from either direction.

By individually collecting the MMSA and QMSA for a connection, each QMSA can be migrated to different gateways to achieve high performance and throughput.

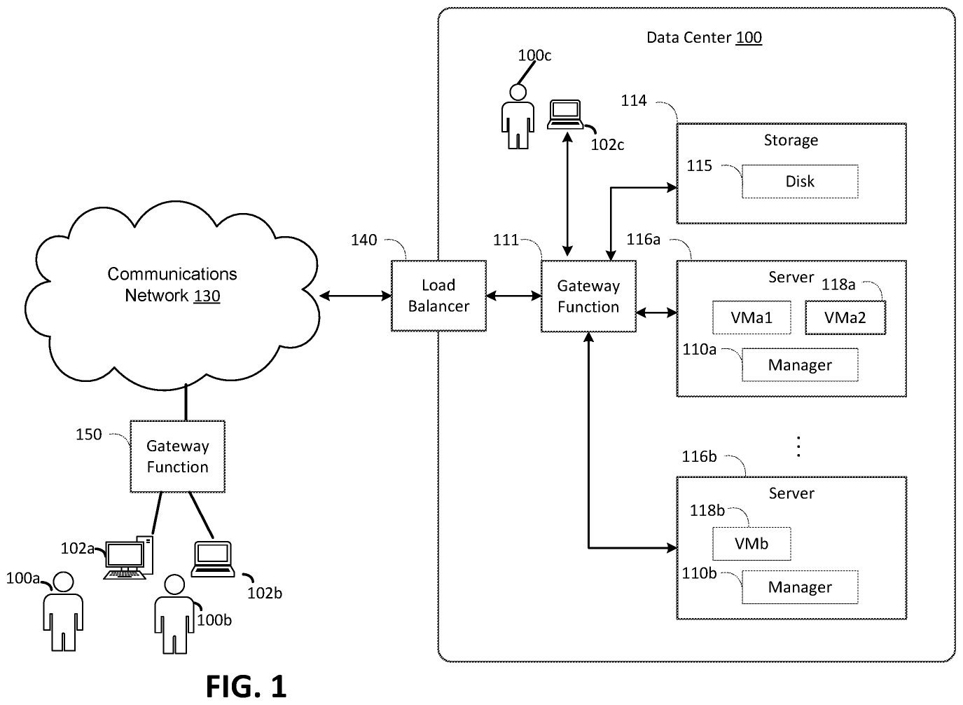

FIG. 1 illustrates an example computing environment in which the embodiments described herein may be implemented. FIG. 1 illustrates a data center 100 that configured to provide computing resources to users 100a, 100b, or 100c (which may be referred herein singularly as “a user 100” or in the plural as “the users 100”) via user computers 102a,102b, and 102c (which may be referred herein singularly as “a computer 102” or in the plural as “the computers 102”) via a communications network 130. The computing resources provided by the data center 100 may include various types of resources, such as computing resources, data storage resources, data communication resources, and the like. Each type of computing resource may be general-purpose or may be available in a number of specific configurations. For example, computing resources may be available as virtual machines. The virtual machines may be configured to execute applications, including Web servers, application servers, media servers, database servers, and the like. Data storage resources may include file storage devices, block storage devices, and the like. Each type or configuration of computing resource may be available in different configurations, such as the number of processors, and size of memory and/or storage capacity. The resources may in some embodiments be offered to clients in units referred to as instances, such as virtual machine instances or storage instances. A virtual computing instance may be referred to as a virtual machine and may, for example, comprise one or more servers with a specified computational capacity (which may be specified by indicating the type and number of CPUs, the main memory size and so on) and a specified software stack (e.g., a particular version of an operating system, which may in turn run on top of a hypervisor).

Data center 100 may include storage resources 114 and servers 116a and 116b (which may be referred to herein singularly as “a server 116” or in the plural as “the servers 116”) that provide computing resources available as disk 115 and virtual machines 118a and 118b (which may be referred to herein singularly as “a virtual machine 118” or in the plural as “the virtual machines 118”). The virtual machines 118 may be configured to execute applications such as Web servers, application servers, media servers, database servers, and the like. Other resources that may be provided include data storage resources (not shown on FIG. 1) and may include file storage devices, block storage devices, and the like. Storage resources 114 and servers 116 may also execute functions that manage and control allocation of resources in the data center, such as a controller. The controller may be a fabric controller or another type of program configured to manage the allocation of virtual machines on storage resources 114 and servers 116.

Referring to FIG. 1, communications network 130 may, for example, be a publicly accessible network of linked networks and may be operated by various entities, such as the Internet. In other embodiments, communications network 130 may be a private network, such as a corporate network that is wholly or partially inaccessible to the public. Communication Network 130 may have a gateway 150 which is connected to gateway 111 in Data Center 100.

Communications network 130 may provide access to computers 102. Computers 102 may be computers utilized by users 100. Computer 102a,102b or 102c may be a server, a desktop or laptop personal computer, a tablet computer, a smartphone, a set-top box, or any other computing device capable of accessing data center 100. User computer 102a or 102b may connect directly to the Internet (e.g., via a cable modem). User computer 102c may be internal to the data center 100 and may connect directly to the resources in the data center 100 via internal networks. Although only three user computers 102a,102b, and 102c are depicted, it should be appreciated that there may be multiple user computers.

Computers 102 may also be utilized to configure aspects of the computing resources provided by data center 100. For example, data center 100 may provide a Web interface through which aspects of its operation may be configured through the use of a Web browser application program executing on user computer 102. Alternatively, a stand-alone application program executing on user computer 102 may be used to access an application programming interface (API) exposed by data center 100 for performing the configuration operations.

Storage resources 114 and servers 116 may be configured to provide the computing resources described above. One or more of the servers 116 may be configured to execute a manager 110a or 110b (which may be referred herein singularly as “a manager 110” or in the plural as “the managers 110”) configured to execute the virtual machines. The managers 110 may be a virtual machine monitor (VMM), fabric controller, or another type of program configured to enable the execution of virtual machines 118 on servers 116, for example.

It should be appreciated that although the embodiments disclosed above are discussed in the context of virtual machines, other types of implementations can be utilized with the concepts and technologies disclosed herein. For example, the embodiments disclosed herein might also be utilized with computing systems that do not utilize virtual machines.

In the example data center 100 shown in FIG. 1, a gateway 111 may be utilized to interconnect the servers 116a and 116b. Gateway 111 may also be connected to load balancer 140, which is connected to communications network 130. Gateway 111 may manage communications within networks in data center 100, for example, by forwarding packets or other data communications as appropriate based on characteristics of such communications (e.g., header information including source and/or destination addresses, protocol identifiers, etc.) and/or the characteristics of the private network (e.g., routes based on network topology, etc.). It will be appreciated that, for the sake of simplicity, various aspects of the computing systems and other devices of this example are illustrated without showing certain conventional details. Additional computing systems and other devices may be interconnected in other embodiments and may be interconnected in different ways.

It should be appreciated that the network topology illustrated in FIG. 1 has been greatly simplified and that many more networks and networking devices may be utilized to interconnect the various computing systems disclosed herein. These network topologies and devices should be apparent to those skilled in the art.

It should also be appreciated that data center 100 described in FIG. 1 is merely illustrative and that other implementations might be utilized. Additionally, it should be appreciated that the functionality disclosed herein might be implemented in software, hardware or a combination of software and hardware. Other implementations should be apparent to those skilled in the art. It should also be appreciated that a server, gateway, or other computing device may comprise any combination of hardware or software that can interact and perform the described types of functionality, including without limitation desktop or other computers, database servers, network storage devices and other network devices, PDAs, tablets, smartphone, Internet appliances, television-based systems (e.g., using set top boxes and/or personal/digital video recorders), and various other consumer products that include appropriate communication capabilities. In addition, the functionality provided by the illustrated modules may in some embodiments be combined in fewer modules or distributed in additional modules. Similarly, in some embodiments the functionality of some of the illustrated modules may not be provided and/or other additional functionality may be available.

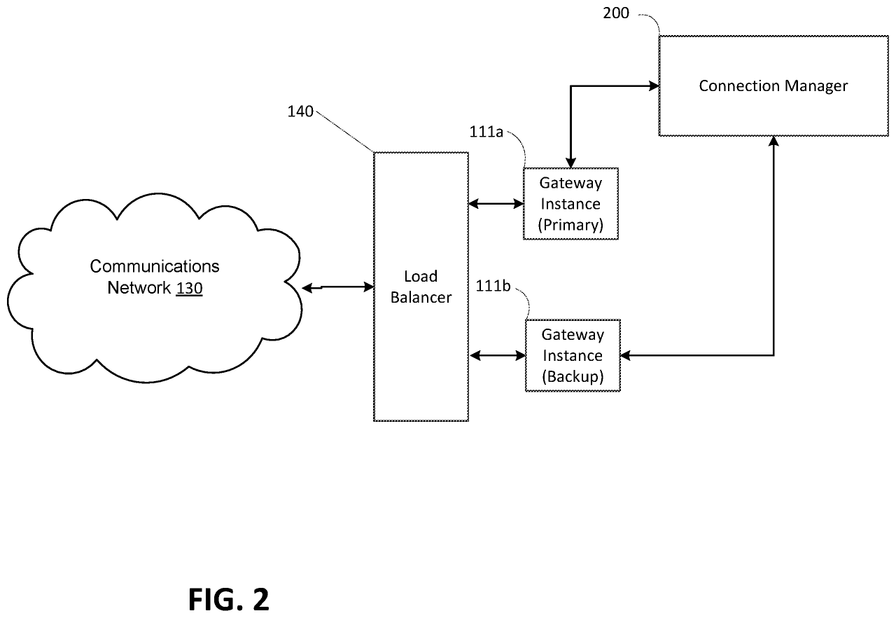

In one embodiment, the service provider providing services via data center 100 may implement a function that is configured to initiate a switchover of a gateway instance. The switchover may be associated with maintenance of the gateway, performance improvements of the network, or load balancing. In some embodiments, such a function may be referred to as a connection manager. A switchover determination may be made based on one or more criteria. The criteria may include one or more of a required change in hardware configuration, a change in software configuration, maintenance requirements for the currently hosting computing device, network performance, and other factors. The criteria may also include operational requirements for the data center, such as collocating virtual machines for communication efficiency, improve security features, to improve load balancing, to retire aging hardware, and the like. For example, the connection manager may determine if the gateway requires or would benefit from being hosted on a computing device with different or improved hardware or software features. The connection manager may determine if a candidate host computing device is available that meets or exceeds the criteria for a machine that has such features. FIG. 2 illustrates a connection manager 200 that communicates with primary gateway instance 111a and backup gateway instance 111b.

To illustrate an example implementation, it can be assumed that a VPN gateway may be implemented as two instances, Instance1 and Instance2, with a virtual IP Vip1, and an upgrade to this gateway is to be performed. Since this is a planned maintenance, the datacenter infrastructure may upgrade instances one by one and also notify instances before starting the upgrade to allow them to gracefully shutdown and to allow for existing connections to be migrated as described herein.

The implementation of a transfer of an existing connection in accordance to the disclosed embodiments may allow for the connections to be live migrated between two devices with reduced or no impact to the users of the connections. As used herein, the source device may refer to the host from which the gateway (or other function) is being migrated. The destination node may refer to the host to which the gateway (or other function) is being migrated.

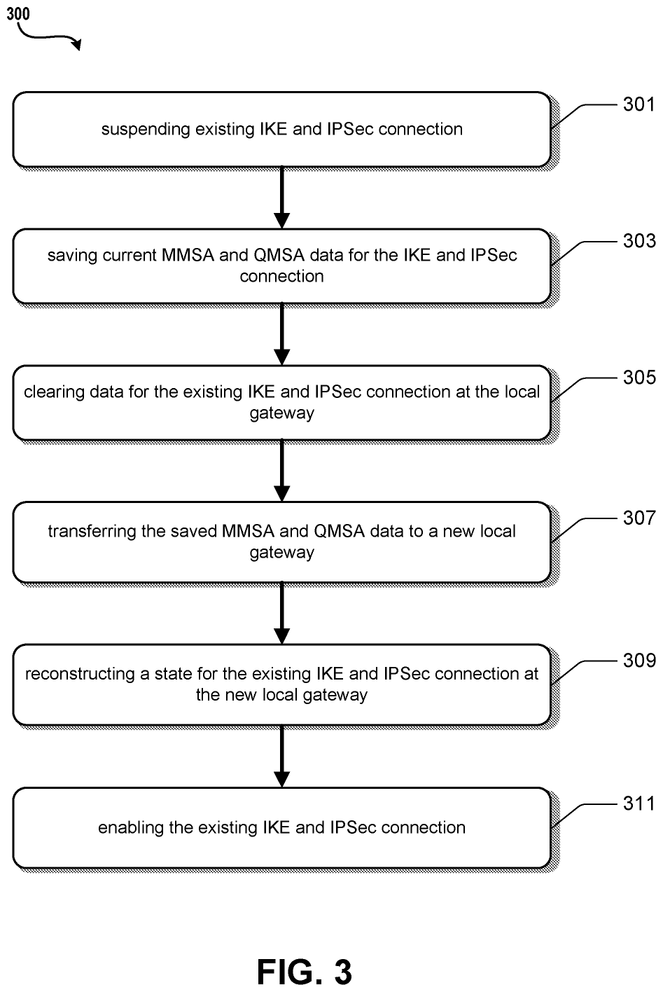

Turning now to FIG. 3, illustrated is an example operational procedure for live migrating an existing connection between a local gateway in a virtualized computing environment and a remote gateway in accordance with the present disclosure. The operational procedure may be implemented in a system comprising one or more computing devices. Referring to FIG. 3, operation 301 illustrates suspending an existing Internet Key Exchange (IKE) and Internet Protocol Security (IPsec) connection between the local gateway and the remote gateway.

Operation 301 may be followed by operation 303. Operation 303 illustrates saving current Main Mode SA (MMSA) and Quick Mode SA (QMSA) data for the IKE and IPSec connection.

Operation 303 may be followed by operation 305. Operation 305 illustrates clearing data for the existing IKE and IPSec connection at the local gateway without sending a message to the remote gateway.

Operation 305 may be followed by operation 307. Operation 307 illustrates transferring the saved MMSA and QMSA data to a new local gateway.

Operation 307 may be followed by operation 309. Operation 309 illustrates using the transferred MMSA and QMSA data, reconstructing a state for the existing IKE and IPSec connection at the new local gateway. In an embodiment, reconstructing the state includes maintaining a previously secure authenticated communication channel of the existing IKE and IPSec connection.

Operation 309 may be followed by operation 311. Operation 311 illustrates enabling the existing IKE and IPSec connection at the new local gateway.

In an embodiment, suspending the existing Internet Key Exchange (IKE) and Internet Protocol Security (IPsec) connection comprises freezing the IKE and IPSec connection so that packets are not processed.

In an embodiment, suspending the existing Internet Key Exchange (IKE) and Internet Protocol Security (IPsec) connection comprises preventing changes to an IKE message ID and IPSec sequence numbers.

In an embodiment, the message is SA_DELETE.

In an embodiment, the method further comprises readjusting timers based on an SA establishment time in In an embodiment, saving current Main Mode SA (MMSA) further comprises collecting one or more of the following parameters from the local gateway:

IKE policy;

connection protocol and type;

IP address of the local and remote gateways;

time when the MMSA was created;

initiator and responder of the MMSA;

current state of the MMSA;

local and remote authentication protocols that were used for authenticating the gateways;

NAT parameters;

Initiator and Responder cookie;

cryptographic parameters;

next incoming IKE request and response message ID; or

number of QMSAs and its corresponding state.

In an embodiment, saving the current Quick Mode SA (QMSA) data further comprises collecting one or more of the following parameters from the local gateway:

MMSA identifier corresponding to the QMSA;

time when the QMSA was created;

initiator and responder of the QMSA;

current state of the QMSA;

local and remote Security Parameter Index;

number of negotiated Traffic Selectors and their details;

QMSA protocol, Authentication Header (AH), or Encapsulating Security Payload (ESP);

cryptographic parameters;

QM key material used to derive keys for cryptographic algorithms; or

next outgoing sequence number and range of incoming sequence numbers.

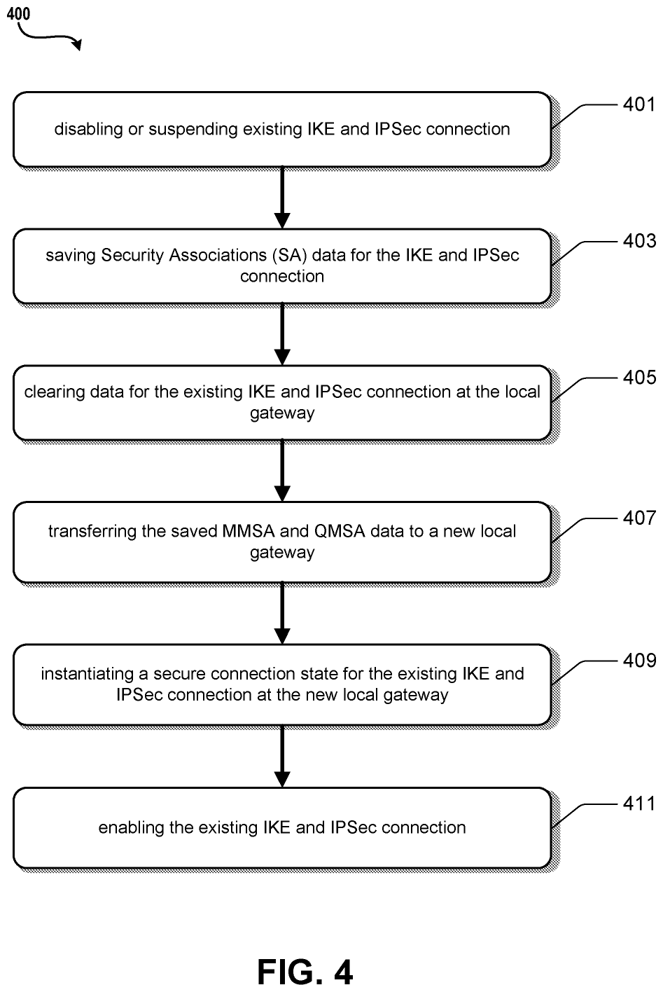

Turning now to FIG. 4, illustrated is an example operational procedure for live migrating an existing connection between a local gateway in a virtualized computing environment and a remote gateway in accordance with the present disclosure. The operational procedure may be implemented in a system comprising one or more computing devices. Referring to FIG. 4, operation 401 illustrates disabling or suspending an existing Internet Key Exchange (IKE) and Internet Protocol Security (IPsec) connection.

Operation 401 may be followed by operation 404. Operation 404 illustrates saving Security Associations (SA) data for the IKE and IPSec connection.

Operation 404 may be followed by operation 405. Operation 405 illustrates clearing data for the existing IKE and IPSec connection at the local gateway.

Operation 405 may be followed by operation 407. Operation 407 illustrates transferring the saved MMSA and QMSA data to a new local gateway.

Operation 407 may be followed by operation 409. Operation 409 illustrates using the saved SA data, instantiating a secure connection state for the existing IKE and IPSec connection at the new local gateway.

Operation 409 may be followed by operation 411. Operation 411 illustrates enabling the existing IKE and IPSec connection at the new local gateway.

In an embodiment, the IKE SA is the Main Mode SA (MMSA) and the IPSec SA is the Quick Mode SA (QMSA).

In an embodiment, clearing data for the existing IKE and IPSec connection is performed without sending a message to the remote gateway.

In an embodiment, suspending the existing Internet Key Exchange (IKE) and Internet Protocol Security (IPsec) connection comprises freezing the IKE and IPSec connection so that packets are not processed.

In an embodiment, suspending the existing Internet Key Exchange (IKE) and Internet Protocol Security (IPsec) connection comprises preventing changes to an IKE message ID and IPSec sequence numbers.

In an embodiment, the message is SA_DELETE.

In an embodiment, the system further comprises computer-readable instructions stored thereupon that, when executed by the one or more processors, cause the system to perform operations comprising readjusting timers based on an SA establishment time in migrated data.

In an embodiment, saving current Main Mode SA (MMSA) further comprises collecting one or more of the following parameters from the local gateway:

IKE policy;

connection protocol and type;

IP address of the local and remote gateways;

time when the MMSA was created;

initiator and responder of the MMSA;

current state of the MMSA;

local and remote authentication protocols that were used for authenticating the gateways;

NAT parameters;

Initiator and Responder cookie;

cryptographic parameters;

next incoming IKE request and response message ID; or

number of QMSAs and its corresponding state.

In an embodiment, saving the current Quick Mode SA (QMSA) data further comprises collecting one or more of the following parameters from the local gateway:

MMSA identifier corresponding to the QMSA;

time when the QMSA was created;

initiator and responder of the QMSA;

current state of the QMSA;

local and remote Security Parameter Index;

number of negotiated Traffic Selectors and their details;

QMSA protocol, Authentication Header (AH), or Encapsulating Security Payload (ESP);

cryptographic parameters;

QM key material used to derive keys for cryptographic algorithms; or

next outgoing sequence number and range of incoming sequence numbers.

The various aspects of the disclosure are described herein with regard to certain examples and embodiments, which are intended to illustrate but not to limit the disclosure. It should be appreciated that the subject matter presented herein may be implemented as a computer process, a computer-controlled apparatus, or a computing system or an article of manufacture, such as a computer-readable storage medium. While the subject matter described herein is presented in the general context of program modules that execute on one or more computing devices, those skilled in the art will recognize that other implementations may be performed in combination with other types of program modules. Generally, program modules include routines, programs, components, data structures and other types of structures that perform particular tasks or implement particular abstract data types.

Those skilled in the art will also appreciate that the subject matter described herein may be practiced on or in conjunction with other computer system configurations beyond those described herein, including multiprocessor systems. The embodiments described herein may also be practiced in distributed computing environments, where tasks are performed by remote processing devices that are linked through a communications network. In a distributed computing environment, program modules may be located in both local and remote memory storage devices.

Networks established by or on behalf of a user to provide one or more services (such as various types of cloud-based computing or storage) accessible via the Internet and/or other networks to a distributed set of clients may be referred to as a service provider. Such a network may include one or more data centers such as data center 100 illustrated in FIG. 1, which are configured to host physical and/or virtualized computer servers, storage devices, networking equipment and the like, that may be used to implement and distribute the infrastructure and services offered by the service provider.

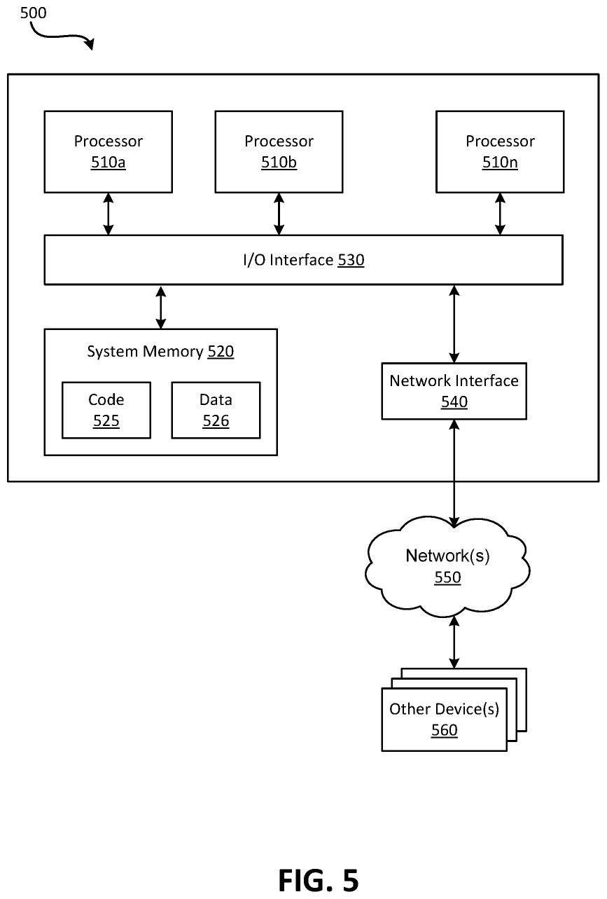

In some embodiments, a server that implements a portion or all of one or more of the technologies described herein, including the techniques to implement the capturing of network traffic may include a general-purpose computer system that includes or is configured to access one or more computer-accessible media. FIG. 5 illustrates such a general-purpose computing device 500. In the illustrated embodiment, computing device 500 includes one or more processors 510a, 510b, and/or 510n (which may be referred herein singularly as “a processor 510” or in the plural as “the processors 510”) coupled to a system memory 520 via an input/output (I/O) interface 530. Computing device 500 further includes a network interface 550 coupled to I/O interface 530.

In various embodiments, computing device 500 may be a uniprocessor system including one processor 510 or a multiprocessor system including several processors 510 (e.g., two, four, eight, or another suitable number). Processors 510 may be any suitable processors capable of executing instructions. For example, in various embodiments, processors 510 may be general-purpose or embedded processors implementing any of a variety of instruction set architectures (ISAs), such as the x86, PowerPC, SPARC, or MIPS ISAs, or any other suitable ISA. In multiprocessor systems, each of processors 510 may commonly, but not necessarily, implement the same ISA.

System memory 520 may be configured to store instructions and data accessible by processor(s) 510. In various embodiments, system memory 520 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing one or more desired functions, such as those methods, techniques and data described above, are shown stored within system memory 520 as code 525 and data 526.

In one embodiment, I/O interface 530 may be configured to coordinate I/O traffic between the processor 510, system memory 520, and any peripheral devices in the device, including network interface 550 or other peripheral interfaces. In some embodiments, I/O interface 530 may perform any necessary protocol, timing, or other data transformations to convert data signals from one component (e.g., system memory 520) into a format suitable for use by another component (e.g., processor 510). In some embodiments, I/O interface 530 may include support for devices attached through various types of peripheral buses, such as a variant of the Peripheral Component Interconnect (PCI) bus standard or the Universal Serial Bus (USB) standard, for example. In some embodiments, the function of I/O interface 530 may be split into two or more separate components. Also, in some embodiments some or all of the functionality of I/O interface 530, such as an interface to system memory 520, may be incorporated directly into processor 510.

Network interface 550 may be configured to allow data to be exchanged between computing device 500 and other device or devices 560 attached to a network or network(s) 550, such as other computer systems or devices as illustrated in FIGS. 1 through 3, for example. In various embodiments, network interface 550 may support communication via any suitable wired or wireless general data networks, such as types of Ethernet networks, for example. Additionally, network interface 550 may support communication via telecommunications/telephony networks such as analog voice networks or digital fiber communications networks, via storage area networks such as Fibre Channel SANs or via any other suitable type of network and/or protocol.

In some embodiments, system memory 520 may be one embodiment of a computer-accessible medium configured to store program instructions and data as described above for FIGS. 1-3 for implementing embodiments of the corresponding methods and systems. However, in other embodiments, program instructions and/or data may be received, sent or stored upon different types of computer-accessible media. A computer-accessible medium may include non-transitory storage media or memory media, such as magnetic or optical media, e.g., disk or DVD/CD coupled to computing device 500 via I/O interface 530. A non-transitory computer-accessible storage medium may also include any volatile or non-volatile media, such as RAM (e.g. SDRAM, DDR SDRAM, RDRAM, SRAM, etc.), ROM, etc., that may be included in some embodiments of computing device 500 as system memory 520 or another type of memory. Further, a computer-accessible medium may include transmission media or signals such as electrical, electromagnetic or digital signals, conveyed via a communication medium such as a network and/or a wireless link, such as may be implemented via network interface 550. Portions or all of multiple computing devices, such as those illustrated in FIG. 5, may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computing device,” as used herein, refers to at least all these types of devices and is not limited to these types of devices.

Various storage devices and their associated computer-readable media provide non-volatile storage for the computing devices described herein. Computer-readable media as discussed herein may refer to a mass storage device, such as a solid-state drive, a hard disk or CD-ROM drive. However, it should be appreciated by those skilled in the art that computer-readable media can be any available computer storage media that can be accessed by a computing device.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computing devices discussed herein. For purposes of the claims, the phrase “computer storage medium,” “computer-readable storage medium” and variations thereof, does not include waves, signals, and/or other transitory and/or intangible communication media, per se.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the disclosed computing devices in order to store and execute the software components and/or functionality presented herein. It is also contemplated that the disclosed computing devices may not include all of the illustrated components shown in FIG. 5, may include other components that are not explicitly shown in FIG. 5, or may utilize an architecture completely different than that shown in FIG. 5.

Although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without author input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be appreciated any reference to “first,” “second,” etc. items and/or abstract concepts within the description is not intended to and should not be construed to necessarily correspond to any reference of “first,” “second,” etc. elements of the claims. In particular, within this Summary and/or the following Detailed Description, items and/or abstract concepts such as, for example, individual computing devices and/or operational states of the computing cluster may be distinguished by numerical designations without such designations corresponding to the claims or even other paragraphs of the Summary and/or Detailed Description. For example, any designation of a “first operational state” and “second operational state” of the computing cluster within a paragraph of this disclosure is used solely to distinguish two different operational states of the computing cluster within that specific paragraph—not any other paragraph and particularly not the claims.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A method for live migrating an existing connection between a local gateway in a virtualized computing environment and a remote gateway, the method comprising:
suspending an existing Internet Key Exchange (IKE) and Internet Protocol Security (IPsec) connection between the local gateway and the remote gateway;
saving current Main Mode SA (MMSA) and Quick Mode SA (QMSA) data for the IKE and IPSec connection;
clearing data for the existing IKE and IPSec connection at the local gateway without sending a message to the remote gateway;
transferring the saved MMSA and QMSA data to a new local gateway;
using the transferred MMSA and QMSA data, reconstructing a state for the existing IKE and IPSec connection at the new local gateway including maintaining a previously secure authenticated communication channel of the existing IKE and IPSec connection; and
enabling the existing IKE and IPSec connection at the new local gateway.

2. The method of claim 1, wherein suspending the existing Internet Key Exchange (IKE) and Internet Protocol Security (IPsec) connection comprises freezing the IKE and IPSec connection so that packets are not processed.

3. The method of claim 1, wherein suspending the existing Internet Key Exchange (IKE) and Internet Protocol Security (IPsec) connection comprises preventing changes to an IKE message ID and IPSec sequence numbers.

4. The method of claim 1, wherein the message is SA_DELETE.

5. The method of claim 1, further comprising readjusting timers based on an SA establishment time in migrated data.

6. The method of claim 1, wherein saving current Main Mode SA (MMSA) further comprises collecting one or more of the following parameters from the local gateway:
IKE policy;
connection protocol and type;
IP address of the local and remote gateways;
time when the MMSA was created;
initiator and responder of the MMSA;
current state of the MMSA;
local and remote authentication protocols that were used for authenticating the gateways;
NAT parameters;
Initiator and Responder cookie;
cryptographic parameters;
next incoming IKE request and response message ID; or
number of QMSAs and its corresponding state.

7. The method of claim 1, wherein saving the current Quick Mode SA (QMSA) data further comprises collecting one or more of the following parameters from the local gateway:
MMSA identifier corresponding to the QMSA;
time when the QMSA was created;
initiator and responder of the QMSA;
current state of the QMSA;
local and remote Security Parameter Index;
number of negotiated Traffic Selectors and their details;
QMSA protocol, Authentication Header (AH), or Encapsulating Security Payload (ESP);
cryptographic parameters;
QM key material used to derive keys for cryptographic algorithms; or
next outgoing sequence number and range of incoming sequence numbers.

8. A system for live migrating an existing connection between a local gateway in a virtualized computing environment and a remote gateway, the system comprising:
one or more processors; and
a memory in communication with the one or more processors, the memory having computer-readable instructions stored thereupon that, when executed by the one or more processors, cause the system to perform operations comprising:
disabling or suspending an existing Internet Key Exchange (IKE) and Internet Protocol Security (IPsec) connection;
saving Security Associations (SA) data for the IKE and IPSec connection;
clearing data for the existing IKE and IPSec connection at the local gateway;
transferring the saved SA data to a new local gateway;
using the saved SA data, instantiating a secure connection state for the existing IKE and IPSec connection at the new local gateway;
and
enabling the existing IKE and IPSec connection at the new local gateway.

9. The system of claim 8, wherein the IKE SA is the Main Mode SA (MMSA) and the IPSec SA is the Quick Mode SA (QMSA).

10. The system of claim 8, wherein clearing data for the existing IKE and IPSec connection is performed without sending a message to the remote gateway.

11. The system of claim 8, wherein suspending the existing Internet Key Exchange (IKE) and Internet Protocol Security (IPsec) connection comprises freezing the IKE and IPSec connection so that packets are not processed.

12. The system of claim 8 wherein suspending the existing Internet Key Exchange (IKE) and Internet Protocol Security (IPsec) connection comprises preventing changes to an IKE message ID and IPSec sequence numbers.

13. The system of claim 10, wherein the message is SA_DELETE.

14. The system of claim 8, further comprising computer-readable instructions stored thereupon that, when executed by the one or more processors, cause the system to perform operations comprising readjusting timers based on an SA establishment time in migrated data.

15. The system of claim 8, wherein saving current Main Mode SA (MMSA) further comprises collecting one or more of the following parameters from the local gateway:
IKE policy;
connection protocol and type;
IP address of the local and remote gateways;
time when the MMSA was created;
initiator and responder of the MMSA;
current state of the MMSA;
local and remote authentication protocols that were used for authenticating the gateways;
NAT parameters;
Initiator and Responder cookie;
cryptographic parameters;
next incoming IKE request and response message ID; or
number of QMSAs and its corresponding state.

16. The system of claim 8, wherein saving the current Quick Mode SA (QMSA) data further comprises collecting one or more of the following parameters from the local gateway:
MMSA identifier corresponding to the QMSA;
time when the QMSA was created;
initiator and responder of the QMSA;
current state of the QMSA;
local and remote Security Parameter Index;
number of negotiated Traffic Selectors and their details;
QMSA protocol, Authentication Header (AH), or Encapsulating Security Payload (ESP);
cryptographic parameters;
QM key material used to derive keys for cryptographic algorithms; or
next outgoing sequence number and range of incoming sequence numbers.

17. A computer-readable storage medium having computer-executable instructions stored thereupon which, when executed by one or more processors of a computing device, cause the computing device to perform operations for live migrating an existing connection between a local gateway in a virtualized computing environment and a remote gateway, the operations comprising:
disabling or suspending an existing Internet Key Exchange (IKE) and Internet Protocol Security (IPsec) connection;
saving Security Associations (SA) data for the IKE and IPSec connection;
clearing data for the existing IKE and IPSec connection at the local gateway;
transferring the saved SA data to a new local gateway;
using the saved SA data, maintaining a previously secure authenticated communication channel of the existing IKE and IPSec connection at the new local gateway;
and
enabling the existing IKE and IPSec connection at the new local gateway.

18. The computer-readable storage medium of claim 17, wherein the IKE SA is the Main Mode SA (MMSA) and the IPSec SA is the Quick Mode SA (QMSA).

19. The computer-readable storage medium of claim 17, wherein clearing data for the existing IKE and IPSec connection is performed without sending a message to the remote gateway.

20. The computer-readable storage medium of claim 17, wherein suspending the existing Internet Key Exchange (IKE) and Internet Protocol Security (IPsec) connection comprises freezing the IKE and IPSec connection so that packets are not processed.
